(19) United States
(12) Patent Application Publication
(10) Pub. No.: US 2023/0332902 A1
(43) Pub. Date: Oct. 19, 2023

(54) TRANSFER GUIDANCE SYSTEM, TRANSFER GUIDANCE METHOD, AND NON-TRANSITORY COMPUTER-READABLE MEDIUM STORING PROGRAM

(71) Applicant: NEC Corporation, Minato-ku, Tokyo (JP)

(72) Inventors: Hirohiko ITO, Tokyo (JP); Sachin Mishra, Tokyo (JP); Akihiko Iketani, Tokyo (JP)

(73) Assignee: NEC Corporation, Minato-ku, Tokyo (JP)

(21) Appl. No.: 18/028,903

(22) PCT Filed: Sep. 24, 2021
(86) PCT No.: PCT/JP2021/035027

§ 371 Date: Mar. 28, 2023

(30) Foreign Application Priority Data
Oct. 6, 2020 (IN) 202011043453

(51) Int. Cl. G01C 21/34; G06Q 10/02

(52) U.S. Cl. CPC G01C 21/3415; G01C 21/3423; G01C 21/3492; G06Q 10/02

(57) ABSTRACT

A transfer guidance system includes at least one memory storing instructions, and at least one processor. The at least one processor is configured to execute the instructions to estimate operation time schedules of a plurality of transportation systems based on track records of operation of the plurality of the transportation systems and generates estimated data, accept request information including locations of departure and destination, generate guidance information for providing information about a route from the location of departure to the location of destination, the route extending over the plurality of the transportation systems, present the guidance information to a user.

### TECHNICAL FIELD

The present disclosure relates to a transfer guidance system, a transfer guidance method, and a non-transitory computer-readable medium storing a program.

### BACKGROUND ART

A transfer guidance system has been developed for use when a user travels to his/her destination using a plurality of transportation systems.

Patent Literature 1 discloses a system in which a provider arranges to pick up a user at a station of a public transportation system around the time at which the user is due to arrive at the station using the public transportation system.

Patent Literature 2 discloses a reservation management system for providing guidance to users of a route extending over a plurality of means of transport and booking the transportation systems that operate on the route. In this system, for example, based on a track record of delay in the bus arrival time during a certain period of time of the day, calculation is performed of the probability that the bus a user is going to travel on will be late. Further, in this system, in the event of an accident or other predetermined events in the transportation systems that operate on the route, calculation is performed of the probability that the transportation systems will return to operating normally after the event within a predetermined period of time.

### CITATION LIST

### Patent Literature

Patent Literature 1: U.S. patent Ser. No. 10/697,783
Patent Literature 2: United States Patent Publication No. 2020/0167702

### SUMMARY OF INVENTION

### Technical Problem

However, in some areas and municipalities, for example, traffic congestion on roads has become the norm and it is thus almost impossible for the public transportation systems to operate on schedule. Further, for reasons other than that mentioned above, there are cases where the transportation systems do not routinely operate on schedule. Under these circumstances, users cannot achieve the desired travel even if the transfer guidance information is provided using the technique described above.

The present disclosure has been made in view of the problem mentioned above, and an object of the present disclosure is to provide a transfer guidance system or the like based on the traffic conditions.

### Solution to Problem

A transfer guidance system according to an example embodiment of the present disclosure includes estimated data generation means, acceptance means, guidance information generation means, and presentation means. The estimated data generation means estimates operation time schedules of a plurality of transportation systems based on track records of operation of the plurality of the transportation systems and generates estimated data. The acceptance means accepts request information including locations of departure and destination. The guidance information generation means generates guidance information for providing information about a transfer route from the location of departure to the location of destination, the transfer route extending over the plurality of the transportation systems. The presentation means presents the guidance information to a user.

A transfer guidance method according to an example embodiment of the present disclosure includes a computer executing the following method. The computer estimates operation time schedules of a plurality of transportation systems based on track records of operation of the plurality of the transportation systems and generating estimated data. The computer accepts request information including locations of departure and destination. The computer generates guidance information for providing information about a transfer route from the location of departure to the location of destination, the transfer route extending over the plurality of the transportation systems. The computer presents the guidance information to a user.

A program according to an example embodiment causes a computer to execute the following steps. The computer estimates operation time schedules of a plurality of transportation systems based on track records of operation of the plurality of the transportation systems and generates estimated data. The computer accepts request information including locations of departure and destination. The computer generates guidance information for providing information about a route from the location of departure to the location of destination, the route extending over the plurality of the transportation systems. The computer presents the guidance information to a user.

### Advantageous Effects of Invention

According to the present disclosure, it is possible to provide a transfer guidance system or the like that matches the traffic conditions.

### BRIEF DESCRIPTION OF DRAWINGS

FIG. 1 is a first block diagram showing a configuration of a transfer guidance system according to an example embodiment;

FIG. 2 is a flowchart showing a transfer guidance method according to an example embodiment;

FIG. 3 is a second block diagram showing a configuration of a transfer guidance system according to an example embodiment;

FIG. 4 is a first diagram showing an example in which a transfer guidance system is used;

FIG. 5 is a second diagram showing an example in which a transfer guidance system is used;

FIG. 6 is a third diagram showing an example in which a transfer guidance system is used;

FIG. 7 is a fourth diagram showing an example in which a transfer guidance system is used;

FIG. 8 is a fifth diagram showing an example in which a transfer guidance system is used;

FIG. 9 is a sixth diagram showing an example in which a transfer guidance system is used; and

FIG. 10 is a seventh diagram showing an example in which a transfer guidance system is used.

### EXAMPLE EMBODIMENT

Hereinbelow, example embodiments of the present disclosure will be described in detail with reference to the drawings. Further, in the drawings, the identical reference symbols denote identical structural elements and redundant explanations thereof are omitted where appropriate for the sake of clarifying the description.

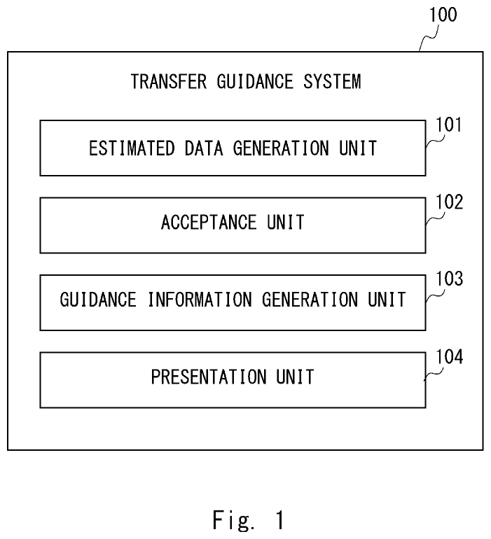

Hereinbelow, example embodiments will be described with reference to the drawings. FIG. 1 is a first block diagram showing a configuration of a transfer guidance system according to an example embodiment. A transfer guidance system 100 includes, as a main configuration thereof, an estimated data generation unit 101, an acceptance unit 102, a guidance information generation unit 103, and a presentation unit 104.

The estimated data generation unit 101 is also referred to as estimated data generation means. The estimated data generation unit 101 estimates the operation time schedules of a plurality of transportation systems based on the track records of operation of the plurality of the transportation systems and generates estimated data.

To be more specific, the estimated data generation unit 101 collects a track record of operation of a predetermined transportation system from an operator of the predetermined transportation system, a municipality, or the like. That is, in order to collect track records of operation of a plurality of transportation systems, the estimated data generation unit 101 is connected to an information processing apparatus owned by each operator of the plurality of transportation systems, a municipality, or the like in such a way that it can communicate with an information processing apparatus owned by each operator of the plurality of transportation systems, a municipality, or the like.

The track record according to the present example embodiment includes data about the route on which the transportation system actually operates and the operation schedule. In more detail, the types of transportation systems are trains, subways, local buses, or water buses that carry passengers and operate on a regular schedule.

Further, the track record according to the present example embodiment includes the traveling time of a specific transportation system that requires booking. A specific transportation system in the present disclosure refers to, for example, a taxi or a transportation system that operates individually like a taxi, and examples thereof include a three-wheeled taxi such as Rickshaw or Tuk-tuk, a motorcycle taxi, and the like. Further, a specific transportation system includes, for example, specific routes and specific seats of limited express trains or trains that requires booking for first-class seats.

Further, the estimated data generation unit 101 generates estimated data from the collected track records. Estimated data is generated using the track records and refers to data in which it is estimated how a given transportation system could operate at a given date and time. That is, the estimated data includes data about the type, the route, and the operation schedule of a transportation system.

For example, the estimated data generation unit 101 performs statistical calculation on the track records according to a predetermined cycle such as the day of the week, the month, or the time of the day. Further, the estimated data generation unit 101 estimates the route and the timetable according to which the transportation system operates. The estimated data can be shown, for example, in a form of a timetable in which the estimated data in shown according to the day of the week, the month, and the time of the day. Further, the estimated data generation unit 101 generates the estimated data taking into account the weather and other irregular or unexpected events. That is, the estimated data generation unit 101 can generate the estimated data according to at least one of the data about the day of the week, the month, or the weather.

The acceptance unit 102 is also referred to as acceptance means. The acceptance unit 102 accepts request information including the locations of departure and destination. To be more specific, the acceptance unit 102 accepts the request information from a user terminal held by a user utilizing the transfer guidance system 100. The request information may include the departure time and the desired arrival time in addition to the information about the locations of departure and destination. Further, the request information may include information about the waypoints.

The guidance information generation unit 103 is also be referred to as guidance information generation means. Based on the estimated data and the request information, the guidance information generation unit 103 generates guidance information for providing information about a transfer route from the location of departure to the location of destination, the transfer route extending over a plurality of transportation systems. That is, the guidance information generation unit 103 generates a transfer route for connecting the location of departure and the location of destination included in the request information received from the user terminal.

The presentation unit 104 is also referred to as presentation means. The presentation unit 104 presents the guidance information to the user. That is, the presentation unit 104 presents guidance information to a user terminal. By this configuration, the user can travel from the location of departure to the location of destination in accordance with the guidance information received through the user terminal.

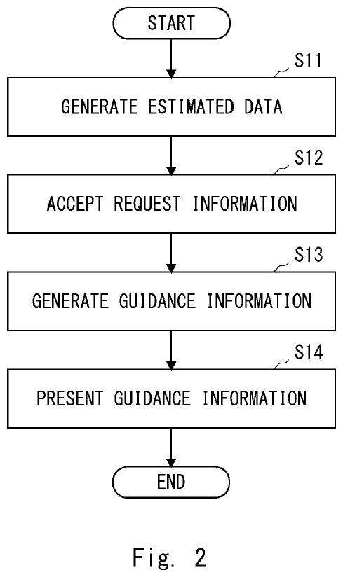

Next, a transfer guidance method executed by the transfer guidance system 100 will be described with the reference to FIG. 2. FIG. 2 is a flowchart showing a transfer guidance method according to an example embodiment.

First, the estimated data generation unit 101 generates estimated data (Step S11). Here, the estimated data generation unit 101 collects the track records from the information processing apparatuses held by the respective operators of a plurality of transportation systems, the municipality, or the like (i.e. the operators). Then, the estimated data generation unit 101 estimates the operation time schedules of the transportation systems from the collected track records to thereby generate estimated data.

Next, the acceptance unit 102 accepts the request information including the locations of departure and destination from the user terminal (Step S12).

Next, based on the estimated data and the request information, the guidance information generation unit 103 generates guidance information for providing information about a route from the location of departure to the location of destination, the route extending over the plurality of the transportation systems (Step S13).

Next, the presentation unit 104 presents the guidance information to the user (Step S14). That is, the presentation unit 104 is supplied with the guidance information for providing information about the route extending over a plurality of transportation systems. Accordingly, the user terminal that has received the aforementioned guidance information can present guidance information it has received to the user.

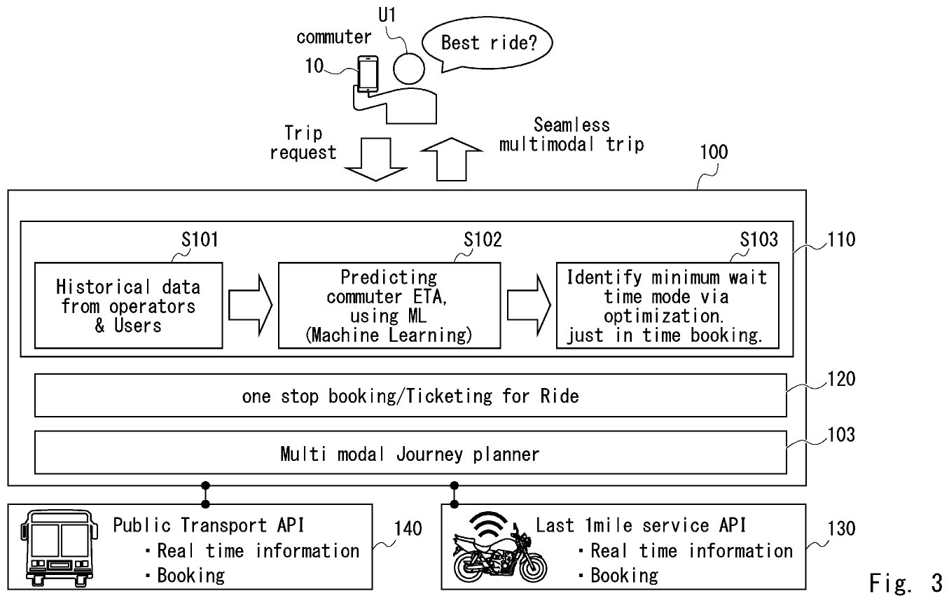

Next, the transfer guidance system 100 will be described in more detail with reference to FIG. 3. FIG. 3 is a second block diagram showing a configuration of a transfer guidance system according to an example embodiment. FIG. 3 shows the transfer guidance system 100 and the peripheral apparatuses connected to the transfer guidance system 100 in such a way that they can communicate with the transfer guidance system 100. That is, FIG. 3 shows the user terminal 10, the transfer guidance system 100, an information processing apparatus 130, and an information processing apparatus 140. The configuration shown in FIG. 3 includes the configuration of the transfer guidance system 100 shown in FIG. 1.

In this configuration, the user terminal 10 and the transfer guidance system 100 are connected to each other in such a way that they can communicate with each other. The user terminal 10 is a mobile communication terminal that belongs to a user U1 (the user U1 is also referred to as commuter), such as a smartphone, a mobile phone, a tablet, or the like. The user terminal 10 supplies the request information to the transfer guidance system 100. The request information is also referred to as Trip request. Further, the user terminal 10 receives the guidance information from the transfer guidance system 100. The guidance information includes contents referred to as Seamless multimodal trip. “Seamless multimodal trip” means including the location of departure, the location of destination, the traveling route, the traveling means, the transfer spot, and the transfer time.

The transfer guidance system 100 shown in FIG. 3 includes a flowchart 110, a booking execution unit 120, and an information processing apparatus 130.

The flowchart 110 indicates the contents that are the same as the contents of the flowchart shown in FIG. 2 but some parts thereof are omitted while some parts are further added.

First, the estimated data generation unit 101 collects record data (also referred to as Historical data) from the operator (Step S101).

Next, the transfer guidance system 100 that has received the request information from the user U1 has the guidance information generation unit 103 generate the transfer route. At this time, the guidance information generation unit 103 estimates the arrival time of the transportation system (Step S102). To be more specific, the guidance information generation unit 103 uses the estimated data generated by the estimated data generation unit 101. Further, in addition to the estimated data, the guidance information generation unit 103 estimates the traveling time for traveling on the transfer route using a specific transportation system that requires booking such as a taxi.

At this time, the transfer guidance system 100 may be able to acquire location information of the user U1 and the time information for providing transfer route guidance. That is, the acceptance unit 102 of the transfer guidance system 100 accepts the date and time at which the user U1 travels from the location of departure to the location of destination as the request information received from the user terminal 10. In this case, the guidance information generation unit 103 can generate guidance information specific to the aforementioned date and time.

Further, the transfer guidance system 100 can take into account the real-time status of the transportation system corresponding to the request information received from the user terminal 10. Accordingly, the transfer guidance system 100 can estimate the traveling time with higher precision.

Note that the transfer guidance system 100 utilizes machine learning in performing the aforementioned estimation. That is, the transfer guidance system 100 collects the record data and generates estimated data from the collected record data utilizing machine learning. Further, the transfer guidance system 100 can utilize machine learning in the case where the guidance information generation unit 103 generates a transfer route.

Next, when the guidance information generation unit 103 generates a transfer route, the transfer guidance system 100 optimizes the route to minimize the waiting time at the time of transferring from one transportation system to another transportation system based on the estimated traveling times of the respective transportation systems (S103). Further, in the case where the transfer guidance route is finalized, the transfer guidance system 100 executes booking processing according to the transfer time in the transfer route as appropriate in the case where the transfer route includes a specific transportation system that requires booking.

In such a case, for example, the guidance information generation unit 103 may generate guidance information according to which the time required to transfer from the first transportation system to the second transportation system that are connected to each other on the transfer route becomes less than the predetermined transfer time. Further, in this case, the guidance information generation unit 103 may set the departure time in the guidance information from the time required to transfer from the first transportation system to the second transportation system on the transfer route. By this configuration, the transfer guidance system 100 enables the user U1 to travel smoother.

The flowchart 110 has been described above. According to the processing shown in the flowchart 110, it is possible to provide guidance information of a route extending over a plurality of transportation systems as requested by the user while suppressing the transfer waiting time.

The transfer guidance system 100 further includes the booking execution unit 120. The booking execution unit 120 is also referred to as booking execution means. The booking execution unit 120 performs booking for a specific transportation system for which booking is required. After the transfer guidance route is finalized and in the case where the specific traffic system is included in the finalized route, the booking execution unit 120 executes booking for the specific transportation system to come and pick up the user U1 at a transfer spot on the route and at the transfer time. To be more specific, the booking execution unit 120 outputs a booking request signal to the information processing apparatus 130 or the information processing apparatus 140 to which the transfer guidance system 100 is connected in such a way that it can communicate with the information processing apparatus 130 or the information processing apparatus 140.

The transfer guidance system 100 includes the guidance information generation unit 103. As shown in FIG. 3, the guidance information generation unit 103 generates transfer guidance, that is, a Journey plan, for a route extending over a plurality of transportation systems.

The transfer guidance system 100 is connected to the information processing apparatus 130 in such a way that it can communicate with the information processing apparatus 130. The transfer guidance system 100 receives the record data from the information processing apparatus 130. The record data may also be referred to as Real time information. Further, the transfer guidance system 100 outputs a booking request signal to the information processing apparatus 130.

The transfer guidance system 100 is connected to the information processing apparatus 140 in such a way that it can communicate with the information processing apparatus 140. The transfer guidance system 100 receives the record data from the information processing apparatus 140. The record data may also be referred to as Real time information. Further, the transfer guidance system 100 outputs a booking request signal to the information processing apparatus 130.

The information processing apparatus 130 is an information processing apparatus managed by the traffic system that provides a so-called the last one mile service. The information processing apparatus 130 is, for example, a computer, a server, or the like and includes an API (Application Programming Interface) for exchanging data with the transfer guidance system 100 as appropriate.

The information processing apparatus 140 is an information processing apparatus that manages a so-called public transportation system such as local buses, trains, and the like. The information processing apparatus 140 includes an API (Application Programming Interface) for exchanging data as appropriate with the transfer guidance system 100.

Owing to the configuration shown in FIG. 3, the transfer guidance system 100 is able to predict the expected arrival time of each transportation system. Further, the transfer guidance system 100 performs matching of the arrival time of the user U1 using the transfer route and the expected arrival time of each transportation system. At this time, the transfer guidance system 100 allocates a time schedule based on a so-called just-in time system for performing the transfer.

Further, the transfer guidance system 100 collects information on a real-time basis from each transportation system and the user terminal 10 belonging to the user U1 that are in a partner-relationship with each transportation system. Further, the transfer guidance system 100 executes booking for the transportation systems that operate on a transfer route extending over a plurality of transportation systems (that is, multimodal trip).

The transfer guidance system 100 can access information about the start of the transfer route (i.e. the first mile) to the last of the transfer route (i.e. the last mile) on a real-time basis by performing processing interactively with the information processing apparatus of the transportation system and the API. By this configuration, the transfer guidance system 100 can generate the optimal transfer route in which the waiting time for the user U1 is shortened. That is, the user U1 can transfer between transportation systems in a seamless manner in the desired route.

Note that the aforementioned estimated data generation unit 101 may generate estimated data based on the operation schedules published by the respective transportation systems. That is, in this case, the estimated data generation unit 101 refers to the record data of operations taking into account the operation schedules and estimates the operation schedules in line with the actual conditions of the transportation systems.

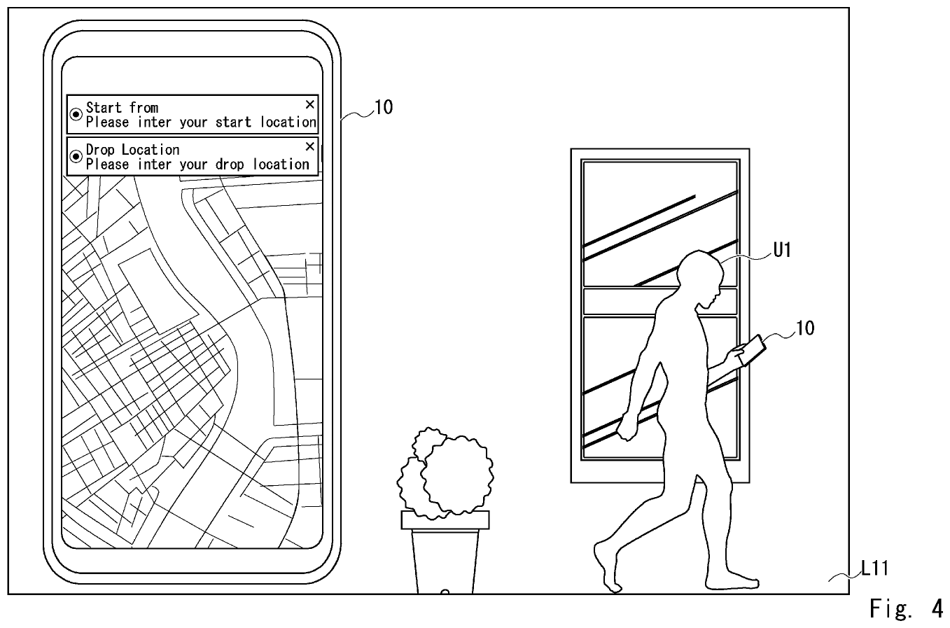

Next, a specific example in which the transfer guidance system 100 is utilized will be described. FIG. 4 is a first diagram showing an example in which a transfer guidance system is used. FIG. 4 indicates a situation where the user U1 operates the user terminal 10 at the location of departure L11 to generate request information.

An example of a screen displayed on the user terminal 10 in the situation shown on the right-hand side in FIG. 4 is shown on the left-hand side in FIG. 4. The screen displayed on the user terminal 10 shown in FIG. 4 is a screen of an application for realizing the transfer guidance method executed by the transfer guidance system 100. The user U1 operates an application of the user terminal whereby the transfer guidance system 100 executes the transfer guidance method.

The user terminal 10 shown in FIG. 4 displays a map along with an indication prompting the user to set the location of departure. The user terminal shown in FIG. 4 has the display and the touch panel sensor superimposed on each other, and the user taps an icon, a button, or the like displayed on the screen whereby the predetermined functions are realized. The user terminal 10 shown in FIG. 4 displays, below the indication prompting the user to set the location of departure, an indication prompting the user to set the location of destination. The user U1 sets the location of departure and the location of destination in accordance with the guidance shown on the screen like the one described above.

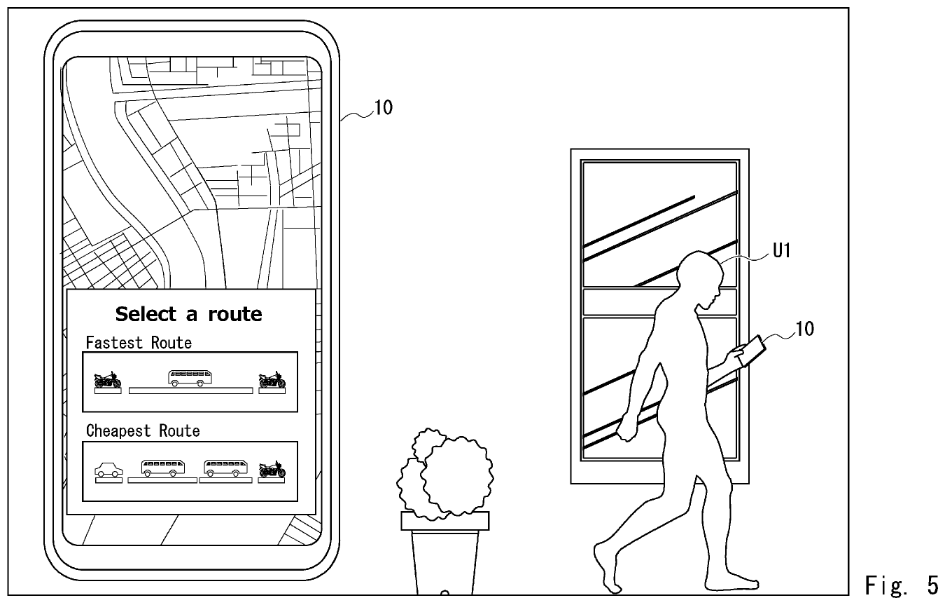

FIG. 5 is a second diagram showing an example in which a transfer guidance system is used. In FIG. 5, “Select a route” is displayed on the user terminal 10 while a plurality of transfer routes are displayed. The transfer guidance system 100 can generate a plurality of different guidance information from the request information received form the user terminal 10. In the example shown in FIG. 5, the transfer guidance system 100 presents the fastest route for reaching the location of destination and the least expensive route (the cheapest route) for reaching the location of destination. The user U1 can select the desired route from these candidates. The transfer guidance system 100 executes a multimodal transfer guidance that matches the transfer route in the selected route.

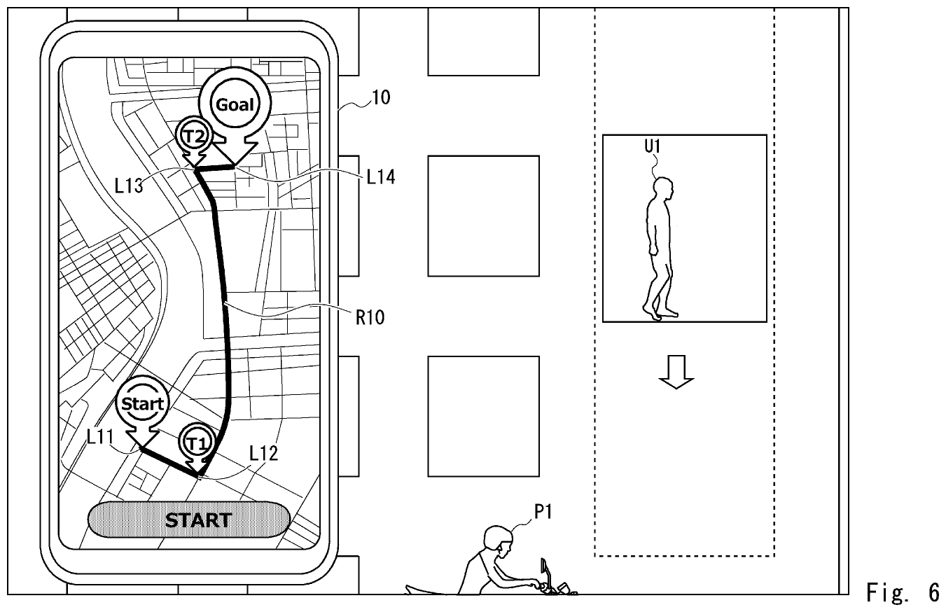

FIG. 6 is a third diagram showing an example in which a transfer guidance system is used. In the image displayed on the screen of the user terminal 10 shown in FIG. 6, the transfer guidance system 100 presents the selected transfer route. On the screen of the user terminal 10, icons marked “Start”, “T1”, “T2”, and “Goal” are displayed. Further, the icons are connected to each other on the screen by a thick line indicating route R10.

The icon marked “Start” indicates the location of departure L11 and indicates the location where the user U1 is present. The icon marked “T1” indicates the first transfer location L12. The icon marked “T2” indicates the second transfer location L13. The icon marked “Goal” indicates the location of destination L14.

In this example, a motorcycle taxi is used from the location of departure L11 to the first transfer location L12. A local bus is used from the first transfer location L12 to the second transfer location L13. Then, a motorcycle taxi is used again from the second transfer location L13 to the location of destination L14.

The user terminal 10 displays a button marked “START” at the bottom of the screen of the user terminal 10. The user U1 taps this button whereby the transfer guidance for the displayed route is finalized. That is, for example, transfer guidance system 100 executes booking as appropriate for the transportation systems that require booking.

After finalizing the transfer guidance, as shown on the right-hand side in FIG. 6, the user U1 commences traveling from the location of departure L11. The first motorcycle taxi P1 waits for the user U1 at the location of departure L11.

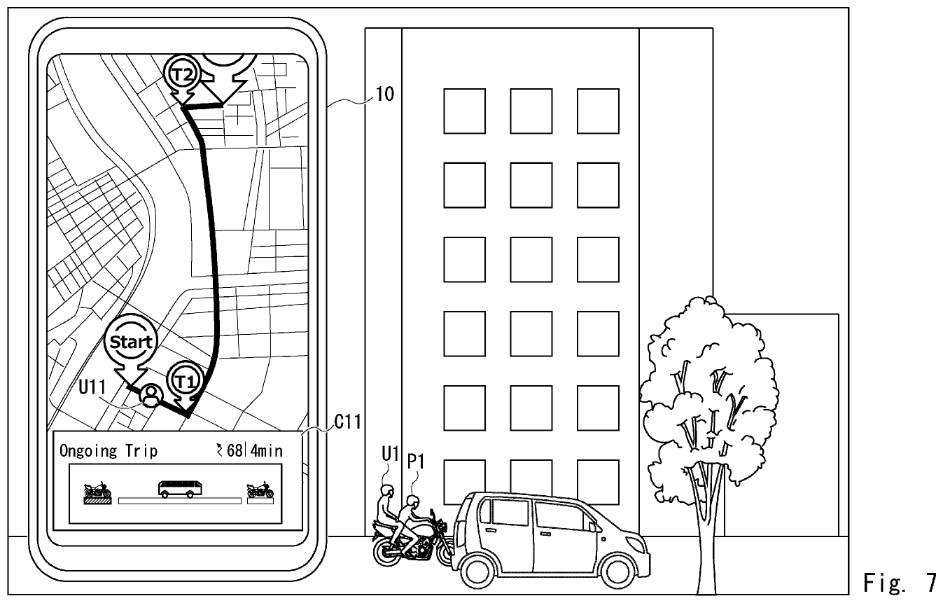

FIG. 7 is a fourth diagram showing an example in which a transfer guidance system is used. On the right-hand side in FIG. 7, a first motorcycle taxi P1 traveling from the location of departure L11 to the first transfer location L12 and the user U1 using the first motorcycle taxi P1 are shown. The first motorcycle taxi P1 carries the user U1 to the first transfer location L12 exactly in time for the predetermined transfer time.

The user terminal 10 shown on the left-hand side in FIG. 7 displays the user icon U11 on the route between the location of departure L11 and the first transfer location L12. The user icon U11 indicates the location where the user U1 is present. Further, the user terminal 10 displays an information image C11 indicating the state of use of the transportation system by the user U1 on the finalized route. As the information image C11, the elapsed time, the distance, and the like may be shown along with a display marked “Ongoing Trip”. Further, the transportation system currently used by the user U1 on the transfer route is highlighted in the information image C11. The motorcycle icon and the block with hatching lines that is shown below the motorcycle icon on the left-hand side in the information image C11 shown in FIG. 7 are highlighted. The hatching lines indicate the motor cycle is in the state of traveling. By this configuration, the user U1 is able to grasp that he/she is currently using the first transportation system on the transfer route.

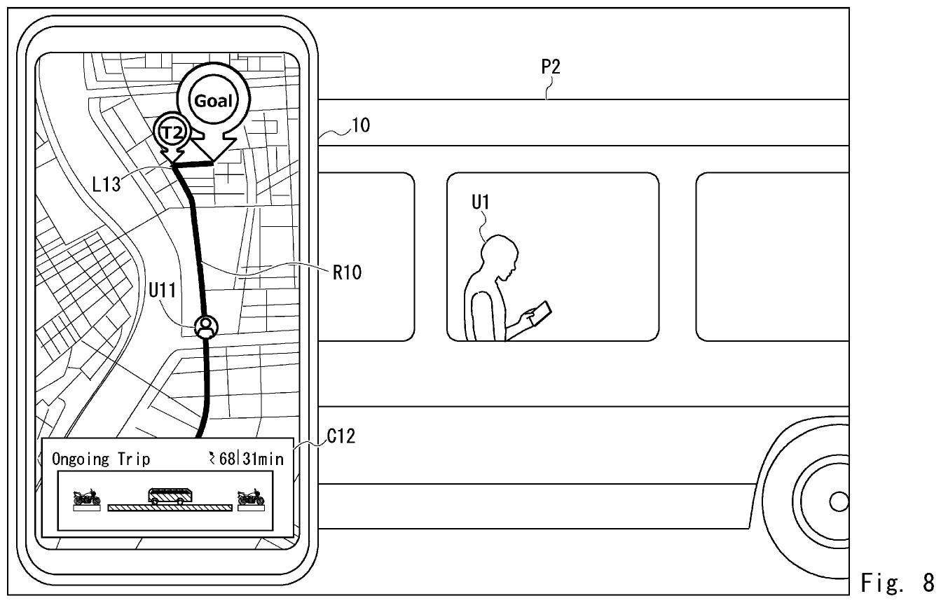

FIG. 8 is a fifth diagram showing an example in which a transfer guidance system used. On the right-hand side in FIG. 8, the user U1 riding on-board a local bus P2 is shown. Further, on the left-hand side in FIG. 8, the user icon U11 moving along the route R10 to the second transfer location L13 is shown. Further, information image C12 is shown at the bottom of the user terminal 10. The local bus icon and the block with hatching lines that is shown below the local bus icon indicating that the local bus is in the state of traveling are highlighted in the information image C12. As described above, the transfer guidance system 100 can display the location of the user U1 on the user terminal 10 as appropriate.

The transfer guidance system 100 may perform booking for a motorcycle taxi to be used from the second transfer location L13 marked “T2”, which is the next transfer location at a timing of, for example, when the user U is moving as shown in FIG. 8. By performing booking for the transportation system to be used in the near future at a predetermined timing while the user is moving, it is possible to accurately estimate the arrival time of the local bus P2 at the second transfer location L13. Accordingly, the transfer guidance system 100 can provide guidance for a smoother transfer.

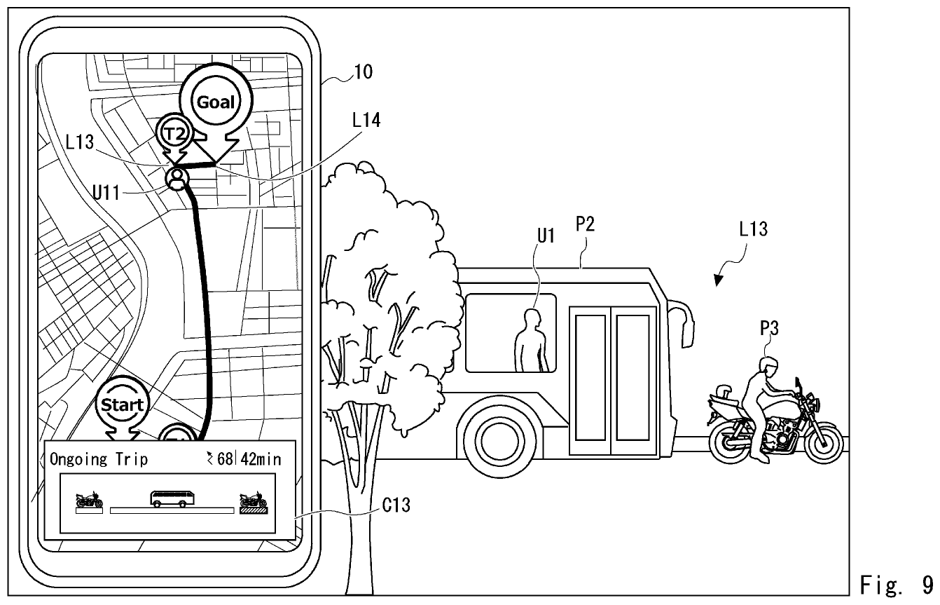

FIG. 9 is a sixth diagram showing an example in which a transfer guidance system is used. FIG. 9 shows a situation in which the user U1 is about to arrive at the second transfer location L13. On the right-hand side in FIG. 9, the user U1 about to get off the local bus P2 that has stopped at the second transfer location L13 is shown. Further, on the right-hand side in FIG. 9, the second motorcycle taxi P3 waiting for the user U1 at the second transfer location L13 is shown. On the left-hand side in FIG. 9, a state in which the user icon U11 has arrived at the second transfer location L13 is shown.

As shown in FIG. 9, the second motorcycle taxi P3 comes to pick up the user U1 at the second transfer location L13 so as not to keep the user U1 waiting. From this location, the user U1 changes the transportation system to the second motorcycle taxi P3 and moves from the second transfer location L13 to the location of destination L14. As described above, the transfer guidance system 100 executes booking for the transportation system that requires booking and operates on the last mile of the transfer route. Accordingly, the user U1 is able to transfer transportation systems smoothly.

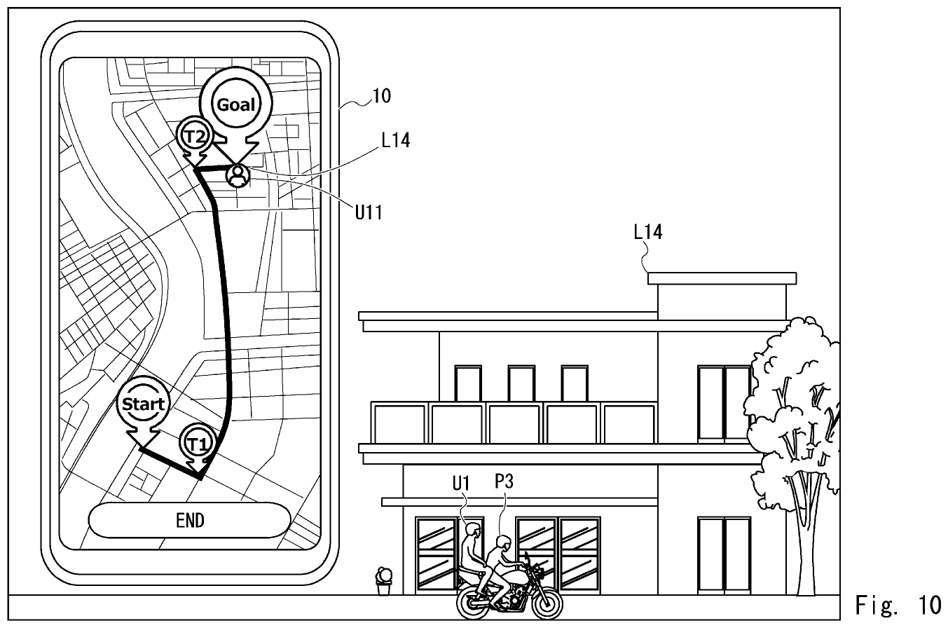

FIG. 10 is a seventh diagram showing an example in which the transfer guidance system is used. FIG. 10 shows a situation in which the second motorcycle taxi P3 with the user U1 on-board are about to arrive at the location of destination L14. On the right-hand side in FIG. 10, a state in which the second motorcycle taxi P3 with the user U1 on board has arrived at the location of destination L14 is shown. The user terminal 10 shown on the left-hand side in FIG. 10 shows a state in which the user icon U11 has arrived at the location of destination L14. After the user U1 arrives at the location of destination, the transfer guidance ends automatically. A button marked “END” is shown at the bottom of the user terminal 10. The user U1 taps this button whereby the transfer guidance application activated on the user terminal 10 ends.

Example embodiments are described above. As described above, the transfer guidance system 100 according to the example embodiment can provide a transfer guidance system or the like that corresponds to the traffic conditions.

Note that the transfer guidance system 100 includes a processor and a storage device as a configuration not shown in the figures. Examples of the storage device included in the transfer guidance system 100 include a flash memory and a non-volatile memory such as SSD (Solid State Drive). The storage device included in the transfer guidance system 100 stores a computer program (hereinafter simple referred to as a program) for realizing the functions according to the present example embodiment. Further, the processor causes the memory to read the computer program from the storage device and executes the program that has been read.

The configuration of each element of the transfer guidance system 100 may be realized by exclusive hardware. Further, whole or a part of the structural elements of the devices may be realized by a general-purpose or dedicated circuitry, processors, etc., or a combination thereof. These elements may be configured as a single chip or may be configured of a plurality of chips connected with one another via a bus. Whole or a part of the structural elements of the devices may be realized by combining the aforementioned circuits and the like and program. Further, as a processor, CPU (Central Processing Unit), GPU (Graphics Processing Unit), FPGA (field-programmable gate array), and the like can be used.

Further, in the case where whole or a part of the structural elements of the transfer guidance system 100 is realized by a plurality of computing apparatuses, circuits, etc., the plurality of computing apparatuses, circuits, etc. may be arranged centrally or in a discretely. For example, the computing apparatuses, circuits, etc. may be realized in a form in which a client server system, a cloud computing system, and the like are connected with one another via a communication network. Further, the transfer guidance system 100 may be provided in a form of SaaS (Software as a Service).

In the aforementioned examples, a program can be stored and provided to a computer using any type of non-transitory computer readable media. Non-transitory computer readable media include any type of tangible storage media. Examples of non-transitory computer readable media include magnetic storage media (e.g. floppy disks, magnetic tapes, hard disk drives), optical magnetic storage media (e.g. magneto-optical disks), CD-ROM (Read Only Memory), CD-R, CD-R/W, semiconductor memories (e.g. mask ROM, PROM (Programmable ROM), EPROM (Erasable PROM), flash ROM, and RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

Note that the present disclosure is not limited to the above-described example embodiments, and can be appropriately changed without departing from the gist of the present disclosure.

This application claims priority based on Indian Patent Application No. 202011043453 filed on Oct. 6, 2020, the disclosure of which is herein incorporated by reference in its entirety.

### INDUSTRIAL APPLICABILITY

The transfer guidance system etc. according to the example embodiment described above may be utilized by, for example, a user who travels on a transfer route by extending over a plurality of transportation systems.

### REFERENCE SIGNS LIST

10 USER TERMINAL
100 TRANSFER GUIDANCE SYSTEM
101 ESTIMATED DATA GENERATION UNIT
102 ACCEPTANCE UNIT
103 GUIDANCE INFORMATION GENERATION UNIT
104 PRESENTATION UNIT
110 FLOWCHART
120 BOOKING EXECUTION UNIT
130 INFORMATION PROCESSING APPARATUS
140 INFORMATION PROCESSING APPARATUS
L11 LOCATION OF DEPARTURE
L12 FIRST TRANSFER LOCATION
L13 SECOND TRANSFER LOCATION
L14 LOCATION OF DESTINATION
U1 USER
U11 USER ICON
R10 ROUTE
P1 FIRST MOTORCYCLE TAXI
P2 LOCAL BUS
P3 SECOND MOTORCYCLE TAXI

What is claimed is:

1. A transfer guidance system comprising:
at least one memory storing instructions, and
at least one processor configured to execute the instructions to;
estimate operation time schedules of a plurality of transportation systems based on track records of operation of the plurality of the transportation systems and generating estimated data;
accept request information including locations of departure and destination;
generate guidance information for providing information about a transfer route from the location of departure to the location of destination, the transfer route extending over the plurality of the transportation systems; and
present the guidance information to a user.

2. The transfer guidance system according to claim 1, wherein at least one processor generates the estimated data by performing machine learning based on the track records.

3. The transfer guidance system according to claim 1, wherein at least one processor generates the estimated data according to at least one of data on day of the week, the month, and the weather.

4. The transfer guidance system according to any one of claim 1, wherein at least one processor generates the estimated data based on operation schedules published by the respective transportation systems.

5. The transfer guidance system according to claim 3, wherein
at least one processor accepts the date and time the user travels from the place of departure to the place of destination as the request information, and
at least one processor generates the guidance information specific to the date and time.

6. The transfer guidance system according to claim 1, wherein at least one processor generates the guidance information according to which the time required to transfer from a first transportation system to a second transportation system that are connected to each other on the transfer route becomes less than a predetermined transfer time.

7. The transfer guidance system according to claim 6, wherein at least one processor sets a departure time in the guidance information based on a transfer time from the first transportation system to the second transportation system on the transfer route.

8. The transfer guidance system according to claim 1, at least one processor is further configured to execute performing booking for a specific transportation system for which booking is required,
wherein in the case where the specific traffic system is included in the transfer route that has been finalized, at least one processor executes booking for the specific transportation system to come and pick up the user at a transfer spot on the transfer route at the transfer time.

9. A transfer guidance method comprising executing, by a computer, a method of:
estimating operation time schedules of a plurality of transportation systems based on track records of operation of the plurality of the transportation systems and generating estimated data;
accepting request information including locations of departure and destination;
generating guidance information for providing information about a transfer route from the location of departure to the location of destination, the transfer route extending over the plurality of the transportation systems; and
presenting the guidance information to a user.

10. A non-transitory computer readable-medium storing a program for causing a computer to execute a transfer guidance method of:
estimating operation time schedules of a plurality of transportation systems based on track records of operation of the plurality of the transportation systems and generating estimated data;
accepting request information including locations of departure and destination;
generating guidance information for providing information about a transfer route from the location of departure to the location of destination, the transfer route extending over the plurality of the transportation systems; and
presenting the guidance information to a user.
